(19) United States
(12) Patent Application Publication
(10) Pub. No.: US 2014/0321355 A1
(43) Pub. Date: Oct. 30, 2014

(54) RELAY USING DEVICE-TO-DEVICE COMMUNICATION IN THE INFRASTRUCTURE-BASED COMMUNICATION SYSTEM

(71) Applicant: Intellectual Discovery Co., Ltd., Seoul (KR)

(72) Inventor: Suhan CHOI, Gwacheon-si (KR)

(73) Assignee: INTELLECTUAL DISCOVERY CO., LTD., Seoul (KR)

(21) Appl. No.: 14/265,318

(22) Filed: Apr. 29, 2014

(30) Foreign Application Priority Data
Apr. 30, 2013 (KR) 10-2013-0048939
Apr. 30, 2013 (KR) 10-2013-0048941
Apr. 30, 2013 (KR) 10-2013-0048942
Apr. 30, 2013 (KR) 10-2013-0048943
Apr. 30, 2013 (KR) 10-2013-0048945

(51) Int. Cl. H04B 7/14

(52) U.S. Cl. CPC H04B 7/14
USPC 370/315

(57) ABSTRACT

Various embodiments of relaying via device-to-device communication in an infrastructure-based communication system are disclosed. A method for operation performed by eNodeB includes communicating with a plurality of UEs, determining the relay master among the UEs based on information on the UEs, notifying a UE determined as the relay master the relay master, and communicating by way of the relay master with a relay slave that is a UE that is not the relay master among the UEs.

### CROSS-REFERENCE TO RELATED APPLICATIONS

The present application is based on, and claims priority to Korean Patent Applications No. 10-2013-0048939, No. 10-2013-0048941, No. 10-2013-0048942, No. 10-2013-0048943, and No. 10-2013-0048945, all of which are filed on Apr. 30, 2013. The disclosures of above-listed applications are hereby incorporated by reference in their entireties for all purposes.

### TECHNICAL FIELD

The present disclosure, in some embodiments, relates to a communication relay via device-to-device communication in an infrastructure-based communication system. More particularly, the present disclosure relates to a base station or network node such an evolved NodeB (eNodeB), a user equipment (UE) and a cellular communication system for performing relay by using a device-to-device communication.

### BACKGROUND

In a wireless communication network, a communication scheme in which a first UE (user equipment) communicates with a second UE through a direct link therebetween (hereinafter, a device-to-device communication scheme) and a communication scheme in which a first UE communicates with a second UE through relaying of a communication infrastructure (an infrastructure-based communication scheme) are known. For example, the first and the second UEs may be cellular UEs and the communication infrastructure may be a cellular eNodeB.

Therefore, technology for effectively using various communication schemes such as a device-to-device communication scheme and the infrastructure-based communication scheme may be needed.

### SUMMARY

An aspect of the present disclosure provides a method for operation including communicating with a plurality of UEs; determining a relay master from the plurality of UEs based on information on the plurality of UEs; notifying a UE determined as the relay master that the UE is determined as the relay master; and communicating with a relay slave by way of the relay master, therelay master being another UE that is not the relay master among the plurality of UEs.

The communicating with the plurality of UEs may include receiving master determination information from the plurality of UEs, and the determining of the relay master may include acquiring at least some of the information on the plurality of UEs based on the received master determination information. The master determination information may include at least one of information indicating whether each UE is a relay master-dedicated UE or not, maximum transmit power, available battery capacity, the number of antennas and a channel state.

In an embodiment, the determining may include determining a UE that is equivalent to the relay master-dedicated UE as the relay master. In another embodiment, the determining of the relay master may include determining the relay master based on at least one of information indicating whether each UE is a relay master-dedicated UE or not, maximum transmit power, available battery capacity, the number of antennas and a channel state. As an example, the determining may include determining the relay master in the following order of priority the maximum transmit power, the available battery capacity, the number of antennas and the channel state. As another example, the determining may include determining the relay master in the following order of priority the available battery capacity, the number of antennas, the channel state and the maximum transmit power. In another embodiment, the determining may include determining the relay master in the following order of priority the maximum transmit power, the available battery capacity, the number of antennas and the channel state, when wide coverage is a service requirement; and in the following order of priority the available battery capacity, the number of antennas, the channel state and the maximum transmit power, when high transmission rate is the service requirement. In still another embodiment, the determining of the relay master may include determining a current service requirement; and determining the relay master based on the determined service requirement.

In one embodiment, the communicating with the relay slave may include transmitting or receiving control data through a direct link with the relay slave and transmitting or receiving information data by way of the relay master. In another embodiment, the communicating with the relay slave may include transmitting or receiving control data and information data by way of the relay master.

The method for operating base station may further include determining whether to switch the relay master function to another UE.

Another aspect of the present disclosure provides a method for operation performed by a UE, including communicating with a base station; receiving a notification from the base station that the UE is determined as a relay master; and relaying communication between the base station and a relay slave that is another UE than the relay master.

The communicating with the base station may include transmitting master determination information of the UE, which indicates information used to determine the relay master by the base station.

The receiving of the notification may include receiving information on the relay slave from the base station. The method for operation may further include setting up relays through communications with the relay slave based on the information on the relay slave. The setting up of the relaying may include receiving an access from the relay slave; and responding to the access.

The responding may include allocating a resource to be used for communication between the UE and the relay slave to the relay slave.

In one embodiment, the receiving of the access from the relay slave may include determining a timing advance used for transmission from the relay slave to the relay master, based on a preamble received from the relay slave, and the responding may include transmitting information on the determined timing advance to the relay slave. In another embodiment, the receiving of the access from the relay slave may include determining a cyclic prefix length of an orthogonal frequency division multiplexing (OFDM) symbol to be used in a link between the relay slave and the relay master, based on a preamble received from the relay slave, the responding may include transmitting information on the determined cyclic prefix length to the relay slave, and the relaying may include transmitting an OFDM symbol having the determined cyclic prefix length in the link between the relay slave and the relay master.

The relaying may include performing an OFDM symbol-based communication to link with the base station and to link with the relay slave, and using different cyclic prefix lengths.

The method for operation may further include transmitting, by the UE, master determination information of the UE to the base station.

Yet another aspect of the present disclosure provides a method for operation performed by a UE, including communicating with a base station; receiving a notification from the base station that the UE is determined as a relay slave; and communicating with the base station by way of a relay master that is one of UEs, that is not the relay slave.

The communicating with the base station may include transmitting master determination information of the UE used to determine the relay master by the base station.

The receiving of the notification may include receiving information on the relay master from the base station. The method for operation may further include setting up relays through communications with the relay master based on the received information. The setting up of replays may include accessing the relay master; and receiving a response from the relay master.

The accessing may include receiving information on a resource for making an initial access to the relay master from the base station; and accessing the relay master using the resource.

In one embodiment, the accessing may include transmitting, to the relay master, a preamble for determining a timing advance used for transmission from the UE to the relay master, and the receiving of the response from the relay master may include receiving information on the determined timing advance from the relay master. In another embodiment, the accessing may include transmitting, to the relay master, a preamble for determining a cyclic prefix length of an OFDM symbol to be used in a link between the relay slave and the relay master, the receiving of the response from the relay master may include receiving information on the determined cyclic prefix length from the relay master, and the communicating with the base station may include transmitting an OFDM symbol having the determined cyclic prefix length in a link between the relay slave and the relay master.

The receiving of the response from the relay master may include allowing the relay master to allocate, for relay, a resource to be used communication between the UE and the relay master.

In one embodiment, the method for operation may further include transmitting master determination information to the base station through a direct link with the base station. In another embodiment, the method for operation may further include transmitting master determination information to the relay master.

Another aspect of the present disclosure provides a method for operation performed by a first UE, including communicating with at least one second UE by using a device-to-device communication scheme; determining a relay master from the first UE and the at least one second UE, based on information on the first UE and the at least one second UE; notifying the determined relay master that is one of the at least one second UE assuming the relay master function; and communicating with a base station by way of the relay master.

The communicating with the at least second UE may include receiving master determination information from the at least one second UE. The determining of the relay master function may include acquiring at least a part of the information on the at least one second UE based on the received master determination information.

The determining of the relay master function may include determining a UE that is equivalent to a relay master-dedicated UE as the relay master.

The determining of the relay master function may include determining the relay master based on at least one of information indicating whether each UE is a relay master-dedicated UE or not, maximum transmit power, available battery capacity, the number of antennas and a channel state.

In one embodiment, the determining of the relay master function may include determining the relay master in the following order of priority the maximum transmit power, the available battery capacity, the number of antennas and the channel state. In another embodiment, the determining of the relay master function may include determining the relay master in the following order of priority the available battery capacity, the number of antennas, the channel state and the maximum transmit power.

The determining of the relay master function may include determining the relay master in the following order of priority the maximum transmit power, the available battery capacity, the number of antennas and the channel state, when wide coverage is a service requirement; and in the following order of priority the available battery capacity, the number of antennas, the channel state and the maximum transmit power, when high transmission rate is the service requirement.

The determining of the relay master function may include determining a current service requirement out of wide coverage and high transmission rate.

The determining of the relay master function may include determining a current service requirement; and determining the relay master based on the determined service requirement.

The method for operation may further include transmitting information on the determined relay master to the base station.

In one embodiment, the method for operation may further include transmitting, by the first UE, information on the base station to the second UE determined as the relay master. In another embodiment, the operation may further include transmitting, by the first UE, information on a relay slave including the first UE to the second UE determined as the relay master. In yet another embodiment, the method for operation may further include transmitting, by the first UE, information on the base station and information on the relay slave to the second UE determined as the relay master.

In one embodiment, the method for operation may further include transmitting, by the first UE, information on the relay master to the relay slave that is any one among at the at least one second UE except for the second UE determined as the relay master. In another embodiment, the method for operation may further include transmitting, by the first UE, to the relay slave, resource information for making an initial access to the relay master. In still another embodiment, the method for operation may further include transmitting, by the first UE, to the relay slave, information on the relay master and resource information for making an initial access to the relay master.

Another aspect of the present disclosure provides a method for operation performed by a first UE, including communicating with a second UE by using a device-to-device communication scheme; receiving a notification from the second UE that the first UE is determined as a relay master; and relaying communication between a base station and a relay slave which is the second UE or a third UE.

The communicating with the second UE may include transmitting master determination information of the first UE indicating information used to determine the relay master by the second UE.

The receiving of the notification may include receiving information on the relay slave from the second UE. The method for operation may further include setting up relays through communications with the relay slave. The setting up of relays may include receiving the access from the relay slave; and responding to the access.

The responding may include allocating a resource to be used for communication between the first UE and the relay slave to the relay slave.

The relaying may include performing communications with the base station by using a first communication scheme and performing communications with the relay slave by using a second communication scheme. The first communication scheme may include an infrastructure-based communication scheme and the second communication scheme may include the device-to-device communication scheme.

In one embodiment, the relaying may include transmitting or receiving control data through a link between the base station and the relay slave, and transmitting information data transmitted from the base station to the relay slave by way of the first UE or transmitting information data transmitted from the relay slave to the base station by way of the first UE. In another embodiment, the relaying may include transmitting or receiving control data and information data by way of the first UE.

The relaying may include performing an OFDM symbol-based communication to link with the base station and to link with the relay slave, and using different cyclic prefix lengths.

Another aspect of the present disclosure provides tangible computer-readable medium containing instructions. The instructions may perform, when executed by a base station or a UE including at least one processor, the methods of the present disclosure.

This summary is provided to introduce a selection of concepts in a simplified form that are further described below in the detailed description. This summary is not intended to identify key features or essential features of the claimed subject matter, nor is it intended to limit the scope of the claimed subject matter. Furthermore, the claimed subject matter is not limited to implementations that solve any or all disadvantages noted in any part of this disclosure. In addition to the above-described exemplary aspects, embodiments, and features, additional aspects, embodiments, and features will become apparent with reference to the detailed description and drawings that follow.

### BRIEF DESCRIPTION OF DRAWINGS

FIGS. 1A and 1B are diagrams showing an infrastructure-based communication scheme and a device-to-device communication scheme.

FIG. 2 is a diagram showing exemplary wireless communication systems according to some embodiments.

FIG. 3 is a diagram showing operations of a base station and UEs according to at least one embodiment of the present disclosure.

FIG. 4 is a diagram showing operations of a base station and UEs according to another embodiment of the present disclosure.

FIG. 5 is a diagram of a method for relay master update according to at least one embodiment of the present disclosure.

FIG. 6 is a diagram of a method for relay master update according to another embodiment of the present disclosure and, more specifically, shows an alternative embodiment of step 562 of FIG. 5.

FIG. 7 is a diagram of a method for relay master update method according to another embodiment of the present disclosure.

FIG. 8 is a diagram showing a situation (A) in which a UE directly communicates with a base station and a situation (B) in which a UE communicates with a relay master.

FIG. 9 is a diagram showing a timing advance usable in the two situations of FIG. 8 according to at least one embodiment of the present disclosure.

FIG. 10 is a diagram showing CP lengths usable in the two situation of FIG. 8 according to at least one embodiment of the present disclosure.

FIG. 11 is a diagram of operations of a base station and UEs according to another embodiment of the present disclosure.

### DETAILED DESCRIPTION

In the following detailed description, reference is made to the accompanying drawings, which form a part hereof. In the drawings, similar reference symbols typically identify similar components, unless context dictates otherwise. The illustrative examples described in the detailed description, drawings and claims are not meant to be limiting. Other examples may be utilized and changes may be made, without departing from the idea or scope of the subject matter presented herein. It will be readily understood that the aspects of the present disclosure, as generally described herein, and illustrated in the drawings, can be rearranged, substituted, combined, separated and designed in a wide variety of different configurations, all of which are explicitly considered herein.

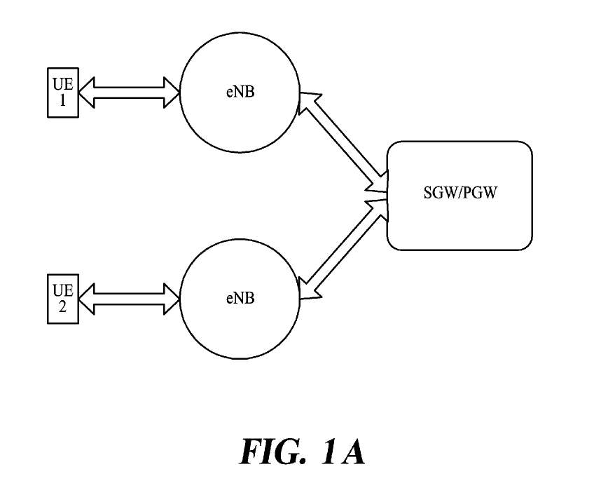

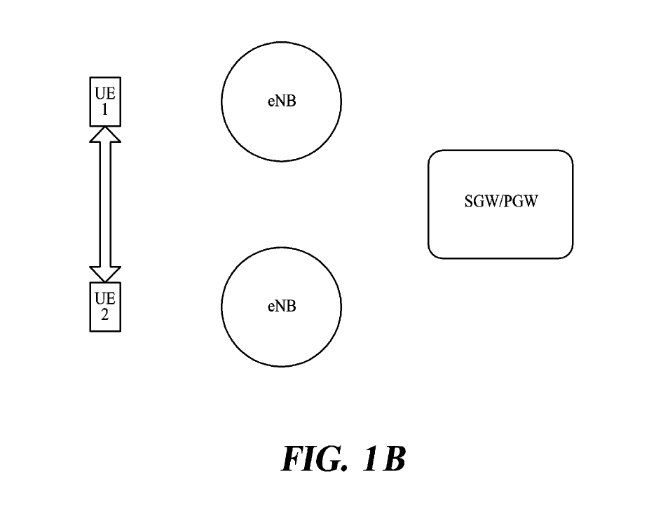

FIGS. 1A and 1B are diagrams showing an infrastructure-based communication scheme and a device-to-device communication scheme.

A mobile communication network based on the 3rd generation partnership project (3GPP) long term evolution (LTE) and LTE-advanced (LTE-A) may be configured with user equipments or UEs, LTE base stations each indicated by eNB (evolved NodeB or eNodeB), a serving gateway (S-GW) responsible for a user plane of a core network, and a packet data network (PDN) gateway (P-GW) as shown in FIG. 1A.

The UE is wirelessly connected to the eNB which is wired to the S-GW and the P-GW. A direct transmission path between UEs is not defined. Accordingly, in order to exchange data between UEs, a transmission path shown in FIG. 1A needs to be involved.

For those “beyond 4G” mobile communication networks, however, direct transmission between UEs as shown in FIG. 1B is considered, which is referred to as device-to-device (hereinafter, D2D) communication.

Carrying out such D2D communication involves various communication scenarios different from conventional communication schemes, and thus needs various technologies.

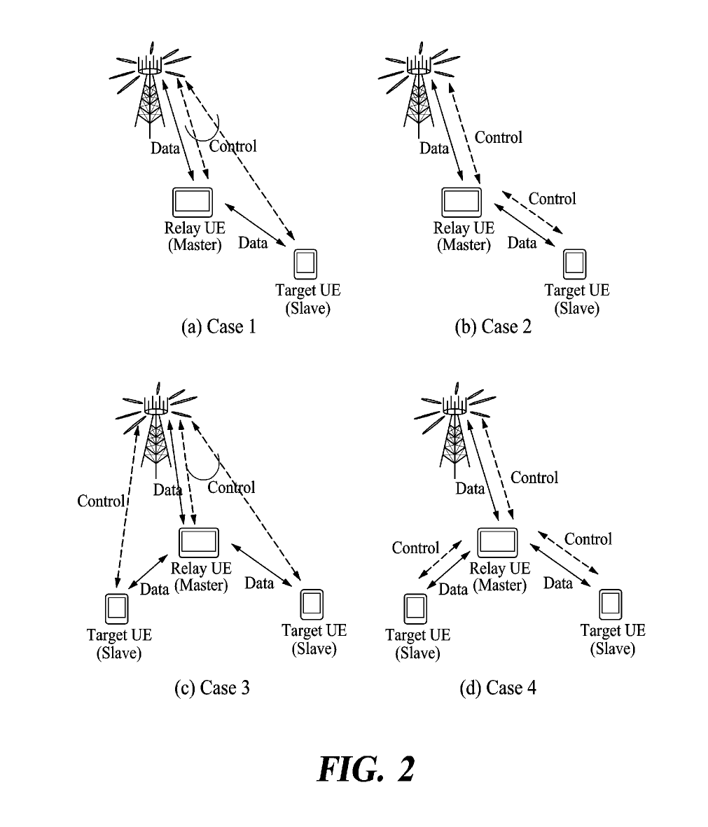

FIG. 2 is a diagram showing exemplary wireless communication systems according to some embodiments.

Especially, the D2D communication enables the following communication scenarios using one UE as a relay node. In FIG. 2, Case 1 shows that a target UE (corresponding to a slave) which is located within a cell coverage area directly exchanges a control signal with an eNB but transmits user data through a nearby relay UE (corresponding to a master) to the eNB when the target UE is too far from the eNB or when the target UE has difficulty receiving high transmission rate data due to e.g., low transmission power. Case 2 shows that a target UE is out of coverage area and cannot directly communicate with an eNB or is in the cell area but with a particular difficulty to make direct communications with the eNB for the transmission of control data (or control information) and user data (or information data) through a neighboring relay UE (master) to the eNB.

The above D2D transmission scenarios between two UEs need a definition of an algorithm for determining a relay UE (master) and a target UE (slave) thereof. This algorithm may be easily extended to D2D scenarios which involves three or more UEs (e.g. Case 3 and Case 4). In other words, the above algorithm is also applicable with little change to a scenario where multiple UEs are defined as one group, from which a UE master is selected with the remaining UEs operating as target UEs (slaves). However, a group composed of three or more UEs may differ a little from the cases involving only two UEs.

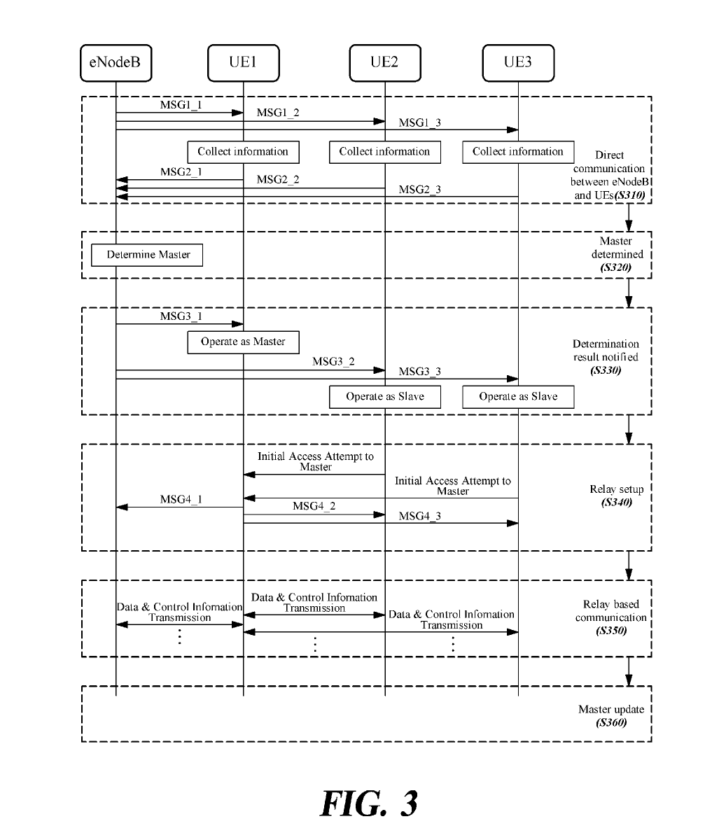

FIG. 3 is a diagram showing operations of an eNodeB and UEs according to at least one embodiment of the present disclosure.

First, the base station eNodeB communicates with each of the user equipments UE1, UE2 and UE3 (at step S310). For example, the eNodeB may transmit messages MSG 1_{—}1, MSG1_{—}2 and MSG1_{—}3 for requesting information for use in determining a relay master (hereinafter, master determination information) to the respective user equipments UE1, UE2 and UE3 and may receive messages MSG2_{—}1, MSG2_{—}2 and MSG2_{—}3 conveying the master determination information of the respective user equipments UE1, UE2 and UE3 therefrom.

Examples of the master-determination information include information indicating whether each UE is a relay master-dedicated UE or not, maximum transmit power of each UE, available battery capacity, the number of antennas (the number of transmit antennas and/or the number of receive antennas) and a channel state. The channel state of a UE may include, but not limited to, reference signal received power (PSRP), reference signal received quality (RSRQ) and channel quality information (CQI). The relay master-dedicated UE may be, for example, a UE installed in a bus, a train, or a subway but is not necessarily limited thereto.

Then, the eNodeB determines a relay master among UE1, UE2 and UE3, based on information on each UE (S320). In the embodiment of FIG. 3, the first UE may be determined as a relay master and the second and third UEs UE2 and UE3 are determined as relay slaves.

Examples of a relay master determination method performed by the eNodeB include determining a UE which is a relay master-dedicated UE as the relay master, determining a UE having the highest maximum transmit power as the relay master, determining a UE having the highest available battery capacity as the relay master, determining a UE having the greatest number of antennas as the relay master, and determining a UE having a superior channel state as the relay master. The information used to determine the relay master may be obtained while the eNodeB initially accesses or usually communicates with UE1, UE2 and UE3 and may also be acquired through request messages MSG1_{—}1, MSG1_{—}2 and MSG1_{—}3.

In an embodiment, the eNodeB may determine a current service requirement and may determine the relay master based on the determined service requirement. As an example, the service requirement my be a wide coverage and, as another example, the service requirement may be a high transmission rate. For example, if a wide coverage is the service requirement with some of the first to third UEs of UE1, UE2 and UE3 located at a cell boundary or edge, the eNodeB may determine the relay master according to conditions, in the following priority order, of whether each UE is a relay master-dedicated UE or not, maximum transmit power, available battery capacity, the number of antennas and a channel state. As another example, if a high transmission rate is the service requirement, the eNodeB may determine the relay master according to conditions, in the following priority order, of whether each UE is a relay master-dedicated UE or not, available battery capacity, the number of antennas, a channel state and maximum transmit power. Exemplary methods for determining the relay master in the priority order of the service requirement include, but not limited to, a method of determining a UE having the higher priority of parameter with higher value as the relay master and a method of determining, as the relay master, a UE having the highest sum of all weighted parameters obtained by applying weights to the parameter values according to priority. However, the relay master determination methods are not necessarily limited thereto.

Next, the eNodeB notifies UE1, UE2 and UE3 of the result of relay master determination (S330).

In some embodiments, the eNodeB transmits, to a UE determined as the relay master, e.g. UE1, the message MSG3_{—}1 notifying that UE1 is determined as the relay master. Information included in the message MSG3_{—}1 for such notification of the relay master determination may be, for example, information on a relay slave. The information on the relay slave may be, e.g. a cell radio network temporary identifier (hereinafter, C-RNTI) of each of the second and third UEs, UE2 and UE3, which are relay slaves.

In some embodiments, the eNodeB transmits, to UE2 and UE3 determined as relay slaves, messages MSG3_{—}2 and MSG3_{—}3 indicating that UE2 and UE3 have been determined as relay slaves. Information included in the messages MSG3_{—}2 and MSG3_{—}3 indicating that UE2 and UE3 have been determined as relay slaves may be, for example, information on a relay master and resource information for initially accessing the relay master. An example of the information on the relay master may be a C-RNTI of the first user equipment UE1 which is the relay master. An example of the resource information for initially accessing the relay master may be an additional channel or time/frequency/code resources.

Next, a relay setup process is performed (S340).

The relay setup at step S340 includes a communication process for relay setup and a process for reporting the completion of relay setup process to the eNodeB.

The communication process for relay setup includes a process for second and third user equipments UE2 and UE3 having been informed of their assignments as the relay slaves to perform initial access to first user equipment UE1 determined as the relay master and another process for first user equipment UE1 having been informed of its assignment as the relay master to respond to initial accesses of UE2 and UE3 through master messages MSG4_{—}2 and MSG4_{—}3 which will be described later.

In some embodiments, upon receiving messages MSG3_{—}2 and MSG3_{—}3 notifying of their assignments as the relay slaves, user equipments UE2 and UE3 perform initial access to the first user equipment UE1 notified of its assignment as the relay master, based on the information on the relay master and the resource information for making an initial access, included in the messages MSG3_{—}2 and MSG3_{—}3.

In some embodiments, the second and third user equipments UE2 and UE3 may use predetermined preambles in the process of initial access to the first user equipment UE1.

In some embodiments, upon receiving the message MSG3_{—}1 notifying of its assignment as the relay master, the first equipment UE1 may transmit, to the second and third equipments UE2 and UE3, the messages MSG4_{—}2 and MSG4_{—}3 for assigning the second and third equipments UE2 and UE3 communication resources to be used in relay links between the relay master and the relay slaves, i.e., a direct link between the first UE and the second UE and a direct link between the first UE and the third UE.

In some embodiments, the first UE may determine timing advances (TAs) to be used for transmissions from the second and third equipments UE2 and UE3 to the first equipment UE1 based on the preambles received through the initial access of the second and third equipments UE2 and UE3 and may transmit messages MSG4_{—}2 and MSG4_{—}3 including the determined TAs to the second and third equipments UE2 and UE3. For example, the first equipment UE1 may calculate the TAs by estimating time delays based on the received preambles.

In some embodiments, first to third user equipments UE1, UE2 and UE3 use orthogonal frequency division multiplexing (OFDM) symbols. The first UE may determine cyclic prefix (CP) lengths of the OFDM symbols to be used in links between the relay master and the relay slaves (i.e. a direct link between the first UE and the second UE and a direct link between the first UE and the third UE) based on the preambles received through initial accesses of the second and third equipments UE2 and UE3 and may transmit the messages MSG4_{—}2 and MSG4_{—}3 including the determined CP lengths to the second and third equipments UE2 and UE3. As an example, the first equipment UE1 may calculate optimal CP lengths by estimating delay spread based on the received preambles.

In some embodiments, the first equipment UE1 may determine the aforementioned TA and CP length based on the same preamble received through initial accesses of the second and third equipments UE2 and UE3 and may transmit the messages MSG4_{—}2 and MSG4_{—}3 including the determined TA and CP length to the second and third equipments UE2 and UE3.

The process of reporting a relay setup completion to the eNodeB may include a process of transmitting, from the first equipment UE1, a relay setup completion reporting message MSG4_{—}1 to the eNodeB.

Next, the eNodeB communicates with the relay slaves UE2 and UE3 via the relay master UE1 (S350). As an example, the relay master UE1 may receive data transmitted from the eNodeB and transmit the data to the corresponding relay slave(s) (UE2 and/or UE3). As another example, the relay master UE1 may receive data from the relay slave UE2 or UE3 and transmit the data to the eNodeB.

In one embodiment, information data transmission between the eNodeB and the second and third equipments UE2 and UE3 may be performed via the relay master UE1, and all or a part of control data transmission between the eNodeB and the second and third equipments UE2 and UE3 may be performed through communication via direct links between the eNodeB and the second and third equipments UE2 and UE3, as shown in Case 1 and Case 3 of FIG. 2. In another embodiment, information data transmission and control data transmission between the eNodeB and the second and third equipments UE2 and UE3 may be performed via the relay master UE, as shown in Case 2 and Case 4 of FIG. 2.

In some embodiments, the relay slaves UE2 and UE3 may communicate with the relay master UE1 by using the communication resources allocated by the first equipment UE1 in the relay setup process (S340).

In some embodiments, the eNodeB and the first to third equipments UE1, UE2 and UE3 use OFDM symbols, and the CP length used in the link between the eNodeB and the relay master UE1 may be different from the CP length used in the link between the relay slave UE2 or UE3 and the relay master UE1. For instance, the CP used in the link between the relay slave UE2 or UE3 and the relay master UE1 may have the length which was determined by the first equipment UE1 through the relay setup process (S340) and was notified to the second and third equipments UE2 and UE3.

In some embodiments, the relay slave UE2 and UE3 may transmit data to the relay master UE using the TAs which are determined by the first equipment UE1 through the relay setup process (S340) and are notified to the second and third equipments UE2 and UE3.

Next, a relay master update may be performed (S360).

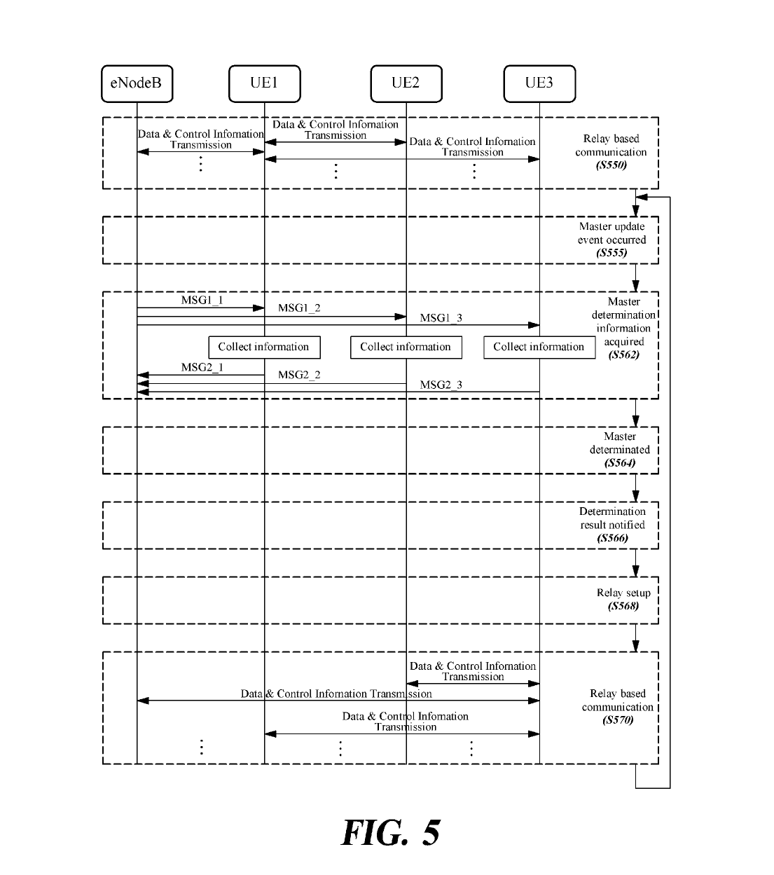

Step S360 will be described in detail later with reference to FIGS. 5 to 7.

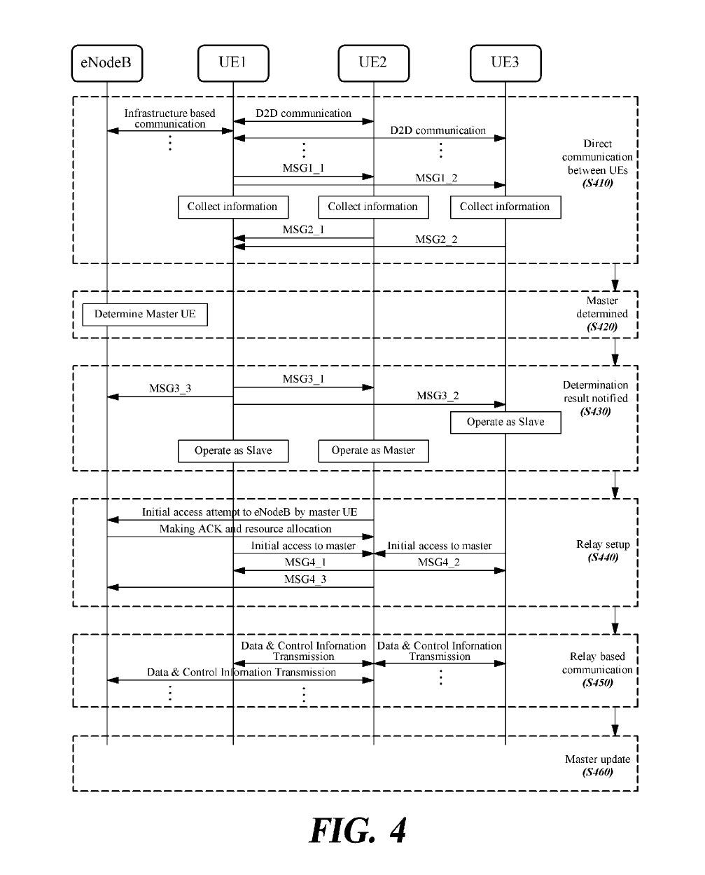

FIG. 4 is a diagram showing operations of eNodeB and UEs according to another embodiment of the present disclosure.

First user equipment UE1, which performs infrastructure-based communication (i.e. normal cellular communication) with an eNodeB, communicates with second and third user equipments UE2 and UE3 through a D2D scheme (S410). An exemplary case of the first equipment UE1 communicating with the second and third equipments UE2 and UE3 through D2D communication is to select the first equipment UE1 as a D2D based master or as a UE group representative and perform D2D communication or D2D based group communication. It may be understood by those skilled in the art that there may be various methods for selecting a master, slave or group representative among a plurality of UEs performing D2D communication.

At step S410, the first equipment UE1 may transmit messages MSG1_{—}1 and MSG1_{—}2 for requesting master determination information to the second and third equipments UE2 and UE3 and may receive messages MSG2_{—}1 and MSG2_{—}2 including the master determination information from the respective equipments UE2 and UE3. Description given with reference to FIG. 3 may be applied to the present embodiment and, therefore, details of the master determination information will not be described herein.

Next, the first equipment UE1 determines a relay master among UE1, UE2 and UE3 based on information on UE2 and UE3 (S420). In the embodiment of FIG. 4, the second equipment UE2 is determined as a relay master and the remaining first and third equipments UE1 and UE3 are determined as relay slaves. The description given with reference to FIG. 3 may be applied to the present embodiment and, therefore, details of the master determination criterion and master determination method will not be described herein.

Next, the first equipment UE1 informs the second and third equipments UE2 and UE3 and the eNodeB of a relay master determination result (S430).

In some embodiments, the first equipment UE1 transmits, to the equipment UE2 determined as the relay master, message MSG3_{—}1 indicating relay master determination. Message MSG3_{—}1 indicating the relay master determination may include, for example, information on the eNodeB and information on the relay slaves. The information on the relay slaves may be C-RNTIs of the first and third equipments UE1 and UE3 which are the relay slaves.

In some embodiments, the first equipment UE1 transmits, to the equipment UE3 determined to be the relay slave, message MSG3_{—}2 indicating relay slave determination. Message MSG3_{—}2 indicating the relay slave determination includes, for example, information on the relay master and resource information for making an initial access to the relay master. The information on the relay master may be a C-RNTI of the second equipment UE2 which is newly assigned a relay master and the resource information may be an additional channel or time/frequency/code resource for making an initial access.

In some embodiments, the first equipment UE1 transmits a message MSG3_{—}3 for reporting the eNodeB of its the relay master assignment. The message MSG3_{—}3 may include information on the relay master.

Thereafter, relay setup is performed (S440).

Relay setup process (S440) may include a communication process for relay setup and a reporting process for reporting the completion of relay setup to the eNodeB.

The communication process for relay setup may include a process for the second equipment UE2 which has been notified of its assignment as the relay master to attempt to access the eNodeB as a new relay master and to receive from the eNodeB, communication resources to be used in a link between the second equipment UE2 and the first equipment UE1 and a link between the second equipment UE2 and the third equipment UE3 in a relay-based communication process (S450); a process for the first equipment UE1 and the third equipment UE3 which have been notified of their assignment as the relay slaves, to perform an initial access to the second equipment UE2, the relay master; and a process for the second equipment UE2 having been notified of its assignment as the relay master to respond to the initial access through messages MSG4_{—}2 and MSG4_{—}3 which will be described later.

In some embodiments, the second equipment UE2 notified of its assignment as the relay master may perform an initial access to the eNodeB based on information included in message MSG3_{—}1 received in the determination result notification process (S430) and may receive communication resources to be used in the link between the second equipment UE2 and the first equipment UE1 and the link between the second equipment UE2 and the third equipment UE3.

In some embodiments, upon receiving message MSG3_{—}2 indicating its assignment as the relay slave, the third equipment UE3 performs the initial access to the second equipment UE2 based on the information on the relay master and the resource information for the initial access, included in message MSG3_{—}2. Since the first equipment UE1 is already aware of the information on the relay master and the resource information for the initial access in the master determination process (S420), the first equipment UE1 also performs an initial access to the second equipment UE2, the relay master.

In some embodiments, the first and third equipments UE1 and UE3 may use a predetermined preamble during the initial access to the second equipment UE2.

In some embodiments, the second equipment UE2 may determine the above-described TA and/or CP length based on the same preamble as received through the initial accesses by the first and third equipments UE1 and UE3 and may transmit messages MSG4_{—}1 and MSG4_{—}2 including the determined TA and/or CP length to the first and third equipments UE1 and UE3. Description given with reference to FIG. 3 may be applied to the present embodiment and, therefore, the determination and use of the TA and CP length will not be described in detail.

The process of reporting the relay setup completion to the eNodeB may include a process for the second equipment UE2 to transmit relay setup completion reporting message MSG4_{—}3 to the eNodeB.

Next, the eNodeB communicates with the relay slaves UE1 and UE3 via the relay master UE2 (S450). Since step S350 may also be equally applied to step S450 except that relay masters are different, a detailed description thereof will not be given.

Next, the relay master update is performed (S460).

FIG. 5 is a diagram of a method for relay master update according to at least one embodiment of the present disclosure.

In an initial state (S550), a relay-based communication is performed by a first equipment UE1 which is determined to be a relay master through an arbitrary relay master determination method (e.g. the method according to the embodiment of FIG. 3 or FIG. 4).

If a master update event occurs (S555) in the relay-based communication process (S550), a master update process is performed at step S562. The master update event may occur when an eNodeB requests master determination information at an update time according to a preset update period, when a UE periodically reports the master determination information even without the request from the eNodeB, or when the eNodeB determines that a master needs to be updated due to change of states (e.g. channel states) of first to third equipments UE1, UE2 and UE3.

Referring to FIG. 5, the eNodeB may transmit messages MSG1_{—}1, MSG1_{—}2 and MSG1_{—}3 for requesting master determination information to a current relay master UE1 and current relay slaves UE2 and UE3 and may receive messages MSG2_{—}1, MSG2_{—}2 and MSG2_{—}3 including master determination information of the respective UEs from the current relay master UE1 and current relay slaves UE2 and UE3 (S562).

Next, the procedure includes: a process for determining a new relay master among UE1, UE2 and UE3, based on information on each UE; a determination result notification process (S566); a relay setup process (S568); and a process (S570) of performing relay-based communication by the new relay master (referring to FIG. 5, third UE). Since steps S564, S566, S568 and S570 may be identically or similarly performed to steps S320, S330, S340 and S350, a detailed description thereof is not given.

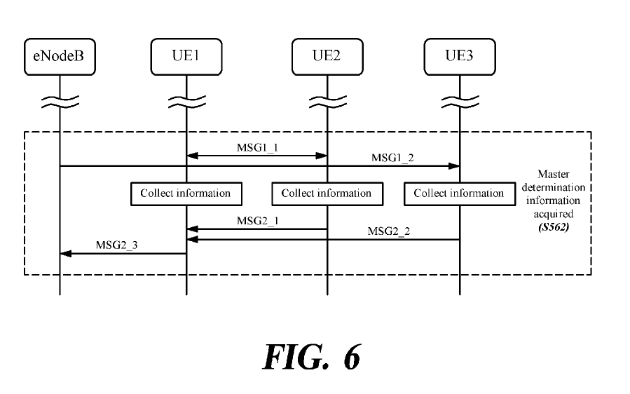

FIG. 6 is a diagram for a method for relay master update according to another embodiment of the present disclosure. More specifically, FIG. 6 shows an alternative embodiment of step S562 of FIG. 5.

Referring to FIG. 6, at step S562′, a current relay master UE1 may transmit messages MSG1_{—}1 and MSG1_{—}2 for requesting master determination information and may receive messages MSG2_{—}1 and MSG2_{—}2 including master determination information of current relay slaves UE2 and UE3. The current relay master UE1 may transmit a message MSG2_{—}3 including the master determination information of the relay slaves UE2 and UE3 and master determination information thereof to an eNodeB.

In another embodiment, the current relay master UE1 may determine whether to perform master update based on the master determination information of the relay slaves UE2 and UE3 and the master determination information thereof and may report the determination result to the eNodeB.

In still another embodiment, the current relay master UE1 may determine whether to perform master update based on the master determination information of the relay slaves UE2 and UE3 and the master determination information thereof and, if it is determined that master update is needed, the current relay master UE1 may transmit the message MSG2_{—}3 including the master determination information of the relay slaves UE2 and UE3 and the master determination information thereof to the eNodeB.

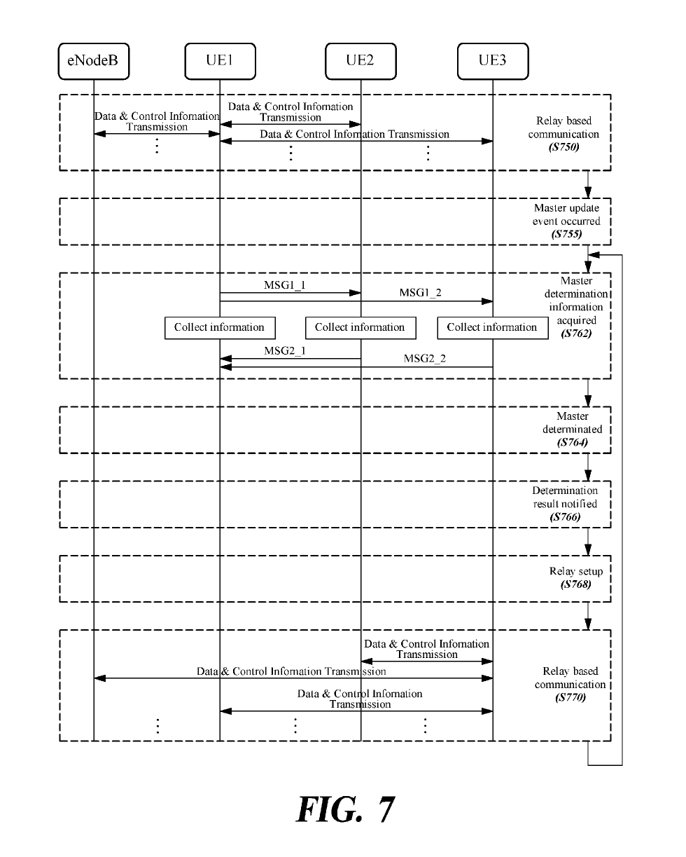

FIG. 7 is a diagram of a method for relay master update according to another embodiment of the present disclosure.

In an initial state (S750), a relay-based communication is performed by a first equipment UE1 which is a determined relay master through one of the relay master determination methods (e.g. the method according to the embodiment of FIG. 3 or FIG. 4).

If a master update event occurs (S755) in the relay-based communication process (S750), a master update process is performed at step S762. Details of the master update event are the same as those described with reference to FIG. 5.

Referring to FIG. 7, a current relay master UE1 may transmit messages MSG1_{—}1 and MSG1_{—}2 for requesting master determination information to current relay slaves UE2 and UE3 and may receive messages MSG2_{—}1 and MSG2_{—}2 including master determination information of the respective UEs from the current relay slaves UE2 and UE3 (S762).

Next, the method for relay master update includes: a process (S764) of determining a new relay master selected among UE1, UE2 and UE3, based on information on each UE; a determination result notification process (S766); a relay setup process (S768); and a process (S770) of performing relay-based communication by the new relay master (referring to FIG. 7, third UE). Since steps S764, S766, S768 and S770 may be identically or similarly performed to steps S420, S430, S440 and S450, detailed descriptions thereof are skipped.

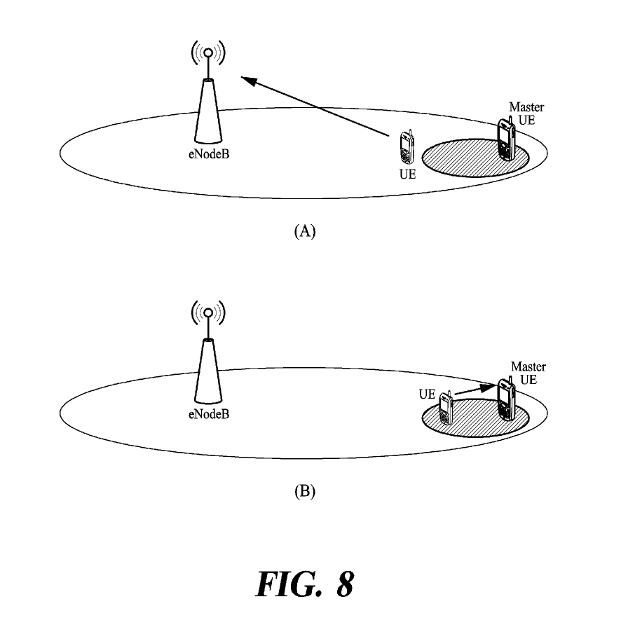

FIG. 8 is a diagram showing a direct communication situation (A) between UE and an eNodeB and a communication situation (B) between a UE and a relay master.

Referring to FIG. 8 at (A), a UE may directly communicate with an eNodeB. Referring to FIG. 8 at (B), a UE may communicate with an eNodeB and another eNodeB (not shown) via a relay master UE which is nearer than the eNodeB.

Referring to FIG. 8, since the distance between the UE and the relay master (master UE) is shorter than the distance between the UE and the eNodeB, a TA and a CP length used in a link between the UE and the relay master (master UE) need to be different from a TA and a CP length used in a link between the UE and the eNodeB, in consideration of time delay and delay spread according to distance.

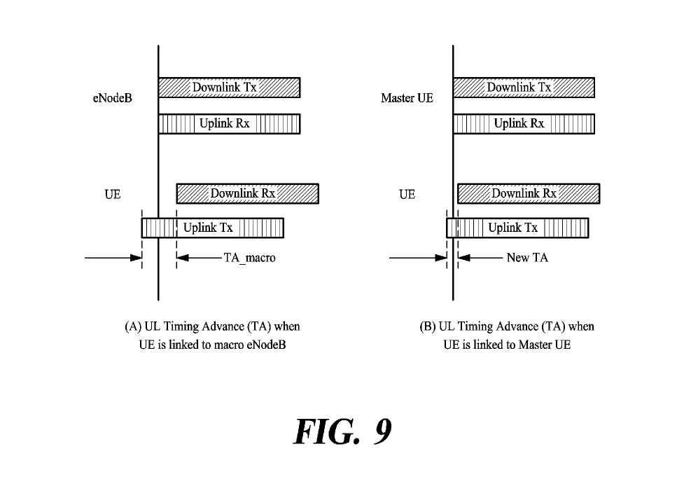

FIG. 9 is a diagram showing TAs usable in the two situations of FIG. 8 according to at least one embodiment of the present disclosure.

FIG. 9 at (A) shows a time delay of downlink and a TA (TA_macro) for uplink when a UE communicates with an eNodeB in the situation of FIG. 8(A).

FIG. 9 at (B) shows a time delay of downlink and a TA (New TA) for uplink when a UE communicates with a relay master UE in the situation of FIG. 8(B).

As illustrated in FIG. 9, the TA (New TA) for a link from the UE to the relay master UE needs to differ from the TA (TA_macro) for a link from the UE to the eNodeB, for the purpose of normal synchronization, reception and/or relaying of the relay master UE.

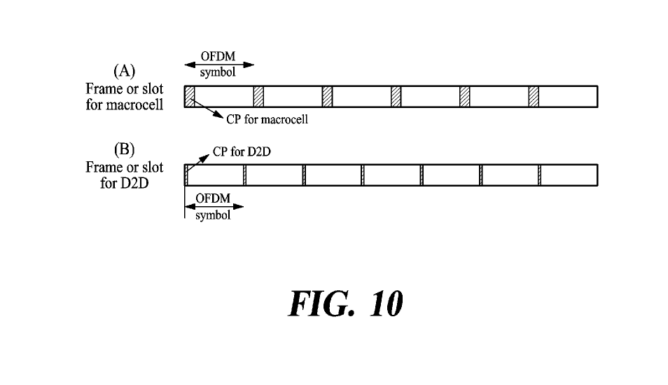

FIG. 10 is a diagram showing CP lengths usable in the two situations of FIG. 8 according to at least one embodiment of the present disclosure.

FIG. 10 at (A) shows a CP length when the UE performs OFDM based communication with an eNodeB in the situation of FIG. 8(A). FIG. 10 at (B) shows a CP length when the UE performs OFDM based communication with the relay master UE in the situation of FIG. 8(B).

As described with reference to FIG. 8, since the link between the UE and the relay master UE is better than the link between the UE and the eNodeB in terms of delay spread, a CP (CP for D2D) used in the link between the UE and the relay master UE is arranged to be shorter than a CP (CP for a macro cell) used in the link between the UE and the eNodeB as shown in FIG. 10 to substantially reduce the overhead and thereby increase the transmission rate.

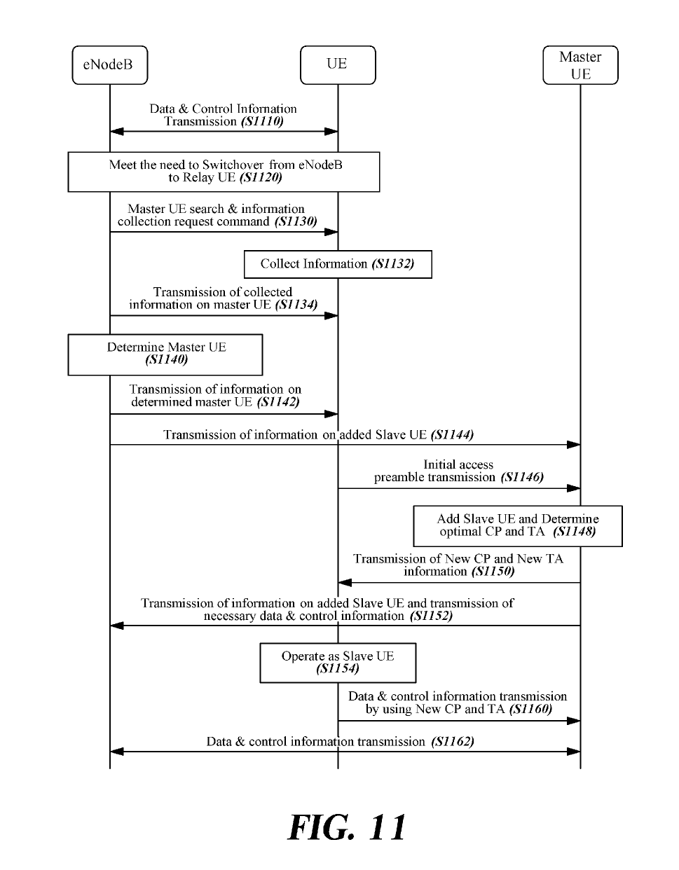

FIG. 11 is a diagram of operations of an eNodeB and UEs according to another embodiment of the present disclosure.

As an example, an eNodeB, a UE and a master UE (relay master UE) of FIG. 11 may correspond to the eNodeB, the UE and the master UE of FIG. 8, respectively.

At step S1110, the UE directly communicates with the eNodeB as shown in FIG. 8(A).

Step S1120 finds an event that the communication linkage of FIG. 8(A) should be switched over to that of FIG. 8(B).

Upon detecting the event, the eNodeB transmits, to the UE, a command for causing the UE to search for a relay master to collect master determination information (S1130).

The UE collects the master determination information in response to the command (S1132) and transmits the collected information to the eNodeB (S1134).

The eNodeB determines the master UE as the relay UE based on the received information (S1140), transmits information on the determined relay master to the UE (S1142), and transmits information on a UE added as a relay slave to the master UE (S1144).

At step S1146, the UE accesses the master UE based on the information received at step S1142. In this process, an initial access preamble may be used.

The master UE adds the UE as the relay slave and determines an optimal CP length and/or TA based on the received preamble (S1148).

The master UE transmits information on the determined CP length and/or TA to the UE (S1150) and transmits, to the eNodeB, a message indicating that a relay setup for the added relay slave has been completed (S1152).

The UE performs as the relay slave (S1154) and communicates with the master UE by using the CP length and/or TA included in the information received at step S1150 (S1160).

The master UE performs as a relay for the UE by communicating with the eNodeB (S1162).

Meanwhile, while the present disclosure describes some embodiments based on the infrastructure-based communication system as the cellular system for convenience of description, the above-described technology may be applied to various communication systems in addition to the cellular communication system. As an example, the technology is applicable to a wireless local area network (LAN) system by regarding an access point and a wireless station as the eNodeB and the UE of FIGS. 3 to 7.

According to some embodiments, the device-to-device communication scheme and infrastructure-based communication scheme can be efficiently used.

One skilled in the art will appreciate that, for this and other processes and methods disclosed herein, the functions performed in the processes and methods may be implemented in differing order. Furthermore, the outlined steps and operations are only provided as examples, and some of the steps and operations may be omitted, combined into fewer steps and operations, or expanded into additional steps and operations without detracting from the essence of the disclosed embodiments.

In an exemplary embodiment, any of operations and processes described in the present disclosure may be achieved by computer-readable instructions stored in a computer-readable medium. The computer readable instructions may be executed by a processor of a mobile device, a constituent of a network and/or any other computing device.

Although the method and apparatus of the present disclosure have been provided to illustrate the disclosure in conjunction with the drawings, it will be apparent to those skilled in the art that the embodiments are given by way of illustration only, and that various modifications and equivalent embodiments can be made without departing from the idea and scope of the disclosure.

What is claimed is:

1. A method for determining a relay master in a wireless communication system including a plurality of user equipments (UEs) and the base station, the method comprising:
communicating with the plurality of UEs;
determining the relay master from the plurality of UEs based on information on the plurality of UEs;
notifying a UE determined as the relay master that the UE is determined as the relay master; and
communicating with a relay slave by way of the relay master, the relay master being another UE that is not the relay master among the plurality of UEs.

2. The method of claim 1, wherein the communicating with the plurality of UEs comprises receiving master determination information from the plurality of UEs, and the determining comprises acquiring at least some of the information on the plurality of UEs based on the received master determination information and determining the relay master.

3. The method of claim 2, wherein the communicating with the plurality of UEs further comprises requesting the plurality of UEs to provide the master determination information.

4. The method of claim 2, wherein the master determination information includes at least one of information indicating whether each UE is a relay master-dedicated UE or not, maximum transmit power, available battery capacity, the number of antennas and a channel state.

5. The method of claim 2, wherein the determining comprises selecting information for determining the relay master from the received master determination information according to a service requirement and determining the relay master based on the selected information.

6. The method of claim 5, wherein the relay master is determined in the following order of priority maximum transmit power, available battery capacity, the number of antennas and a channel state, when the service requirement is wide coverage.

7. The method of claim 5, wherein the relay master is determined in the following order of priority available battery capacity, the number of antennas, a channel state and maximum transmit power, when the service requirement is high transmission rate.

8. The method of claim 1, wherein the notifying further comprises
transmitting information on the relay slave to the relay master.

9. The method of claim 1, further comprising
transmitting, to the relay slave, at least one of information on the relay master and resource information for making an initial access to the relay master.

10. The method of claim 1, further comprising
receiving, from the relay master, a message for reporting that a relay setup has been completed.

11. The method of claim 1, wherein the communicating with the relay slave comprises
communicating with the relay master by using a communication scheme different from a communication scheme between the relay master and the relay slave.

12. The method of claim 11, wherein the different communication scheme with the relay master includes an infrastructure-based communication scheme and the communication scheme between the relay master and the relay slave uses a device-to-device communication scheme.

13. The method of claim 1, wherein the communicating with the relay slave comprises
transmitting or receiving control data through a direct link with the relay slave and transmitting or receiving information data by way of the relay master.

14. The method of claim 1, wherein the communicating with the relay slave comprises
transmitting or receiving control data and information data by way of the relay master.

15. The method of claim 1, wherein the communicating with the relay slave comprising
performing an orthogonal frequency division multiplexing (OFDM) symbol-based communication to link with the relay master and to link between the relay master and the relay slave; and
using different cyclic prefix lengths.

16. The method of claim 1, further comprising
determining whether to switch the relay master function to another UE.

17. The method of claim 16, wherein the determining of whether to switch the relay master function comprises:
receiving master determination information of the plurality of UEs from the UEs; and
determining whether to switch the relay master function based on the received master determination information.

18. The method of claim 16, wherein the determining whether to switch the relay master function comprises:
receiving master determination information of the plurality of UEs from the relay master; and
determining whether to switch the relay master function based on the received master-determination information.

19. A method for operation performed by a user equipment (UE) in a wireless communication system including a plurality of UEs and a base station, the method comprising:
communicating with the base station;
receiving a notification from the base station that the UE is determined as a relay master; and
relaying communications between the base station and a relay slave that is a UE that is not the relay master.

20. The method of claim 19, wherein the receiving of the notification comprises:
receiving information on the relay slave from the base station; and
setting up relays through communications with the relay slave based on the information on the relay slave.

21. The method of claim 20, wherein the setting up of relays comprises:
receiving an access from the relay slave;
allocating a resource to be used for communications with the relay slave to the relay slave; and
communicating with the relay slave by using the allocated resource.

22. The method of claim 20, wherein the setting up of relays comprises:
receiving an access from the relay slave;
determining at least one of a timing advance and a cyclic prefix length based on a preamble received from the relay slave; and
transmitting, to the relay slave, information on the at least one of the timing advance and the cyclic prefix length determined.

23. A method for operation performed by a user equipment (UE) in a wireless communication system including a plurality of UEs and a base station, the method comprising:
communicating with the eNodeB;
receiving a notification from the base station that the UE is determined as a relay slave; and
communicating with the base station by way of a relay master that is one of UEs, that is not the relay slave.

24. The method of claim 23, wherein the receiving of the notification comprises:
receiving information on the relay master from the base station; and
setting up relays through communications with the relay master based on the information on the relay master.

25. A method for operation performed by a first user equipment (UE) in a wireless communication system including a plurality of UEs and a base station, the method comprising:
communicating with at least one second UE by using a device-to-device communication scheme;
determining a relay master from the first UE and the at least one second UE, based on information on the first UE and the at least one second UE;
notifying the determined relay master that is one of the at least one second UE of assuming the relay master function; and
communicating with the base station by way of the relay master.

26. A method for operation performed by a first user equipment (UE) in a wireless communication system including a plurality of UEs and a base station, the method comprising:
communicating with a second UE by using a device-to-device communication scheme;
receiving a notification from the second UE that the first UE is determined as a relay master; and
relaying communications between the base station and a relay slave that is the second UE or a third UE.
